(19) United States
(12) Patent Application Publication
(10) Pub. No.: US 2014/0124294 A1
(43) Pub. Date: May 8, 2014

(54) Climbing Apparatus

(71) Applicant: Chantelle Daizadeh, Scottsdale, AZ (US)

(72) Inventor: Chantelle Daizadeh, Scottsdale, AZ (US)

(21) Appl. No.: 13/668,755

(22) Filed: Nov. 5, 2012

(51) Int. Cl. E06C 1/26; E06C 7/46; E06C 7/18

(52) U.S. Cl. 182/106; 182/129; 182/108

(57) ABSTRACT

A climbing apparatus comprises a plurality of steps secured between parallel side walls. Steps ascend from a lower position to a higher position at which they are secured to an end wall. End wall is perpendicular to the side walls and secured to the side walls with corner members. Corner members are at least partially hollow to accommodate vertically reciprocating adjustable handles. Adjustable handles preferably have a curved end to secure to and accommodate the sides of a shopping cart and can be locked at one or more vertical positions. End wall, corner members, side walls, and steps can be separate components fixedly attached with adhesive or fasteners or they can be integral with one another. Steps can include slip-resistant features, one or more non-slip feet can be placed on the underside of the climbing apparatus, and a safety gate can be included as well.

### FIELD OF THE INVENTION

The present invention relates to an apparatus for climbing to an elevated location and, more particularly, to apparatus for aiding children with climbing to a shopping cart child seat.

### BACKGROUND OF THE INVENTION

Shopping carts often have seats located near one end of the shopping basket. In order for a child to get into the seat, the child has to be lifted by a caregiver and placed in the seat or the child must climb up the side of the shopping cart. When a child is young and not walking or climbing yet, it is relatively easy to lift the child to the seat. When a child is older or heavier, however, it can be difficult or impossible for the caregiver to lift the child. When a child is accomplished at walking and climbing, the child often wants to climb up the side of the shopping cart and get into the seat on their own, which can be dangerous.

For the above reasons, it would be desirable to provide an apparatus that allows a supervised child to climb to the shopping cart seat with little assistance. It would be further desirable to provide an apparatus that can adjust to accommodate shopping carts of various heights. Finally, it would be desirable to provide an apparatus that is sufficiently attractive to children such that they are discouraged from trying to climb the side of the shopping cart.

### SUMMARY OF THE INVENTION

The climbing apparatus comprises a plurality of steps secured between parallel end walls. The steps ascend relative to the floor or ground from a lower position to a higher position at which they are secured to an end wall. The end wall is perpendicular to the side walls and secured to the side walls with corner members. The corner members are at least partially hollow to accommodate vertically reciprocating adjustable handles. Adjustable handles have a curved end to secure to and accommodate the sides of a shopping cart. Each adjustable handle can be locked at one or more vertical positions. The end wall, corner members, side walls, and steps can be separate components fixedly attached with adhesive or fasteners or they can be integral with one another. They can be formed of molded plastic, wood, metals, or wood-plastic composites. The steps can further include a non-slip coating or non-slip features. One or more optional non-skid feet can be placed on the underside of the side walls or end wall as well. A safety gate can be secured at one end of the apparatus to prevent children from climbing without adult supervision.

### BRIEF DESCRIPTION OF THE DRAWINGS

FIG. 1 is a perspective view of the climbing apparatus of the present invention positioned adjacent a shopping cart.

FIG. 2 is a first side view of the climbing apparatus of the present invention positioned adjacent a shopping cart.

FIG. 3 is a second side view of the climbing apparatus of the present invention positioned adjacent a shopping cart.

FIG. 4 is a top view of the climbing apparatus of the present invention positioned adjacent a shopping cart.

FIG. 5 is a side view of the adjustable handle of the present invention as positioned in the corner member of the climbing apparatus.

FIG. 6 is a side view of the climbing apparatus with a first alternative side wall.

FIG. 7 is a side view of the climbing apparatus with a second alternative side wall.

FIG. 8 is a side view of the climbing apparatus with a third alternative side wall.

FIG. 9 is a side view of an alternative adjustable handle of the present invention as positioned in the corner member of the climbing apparatus.

FIG. 10 is a side view of the climbing apparatus with a fourth alternative side wall and a safety gate assembly.

FIG. 11 is a side view of the climbing apparatus with a safety gate assembly.

FIG. 12 is a perspective view of the climbing apparatus of the present invention with optional labels and positioned adjacent a shopping cart.

### DETAILED DESCRIPTION OF PREFERRED EMBODIMENTS

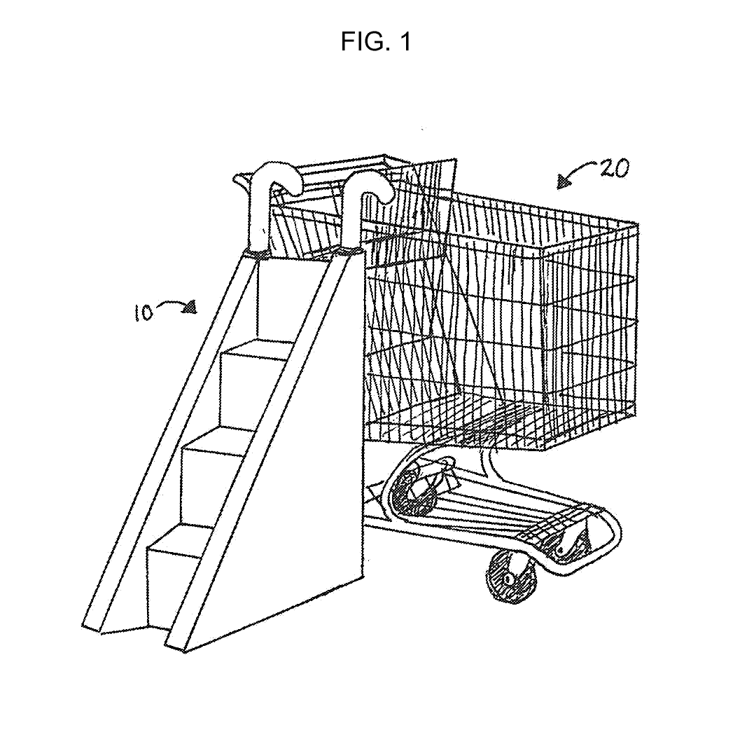

FIG. 1 illustrates the climbing apparatus 10 of the present invention as it is positioned to cooperate with a shopping cart 20. Climbing apparatus 10 can be used to facilitate a child's access to the seated portion of a traditional shopping cart or it can be used to facilitate a child's access to similar elevated seats such as seats on a swing, seats on a carousel, and seats on a cart or carriage.

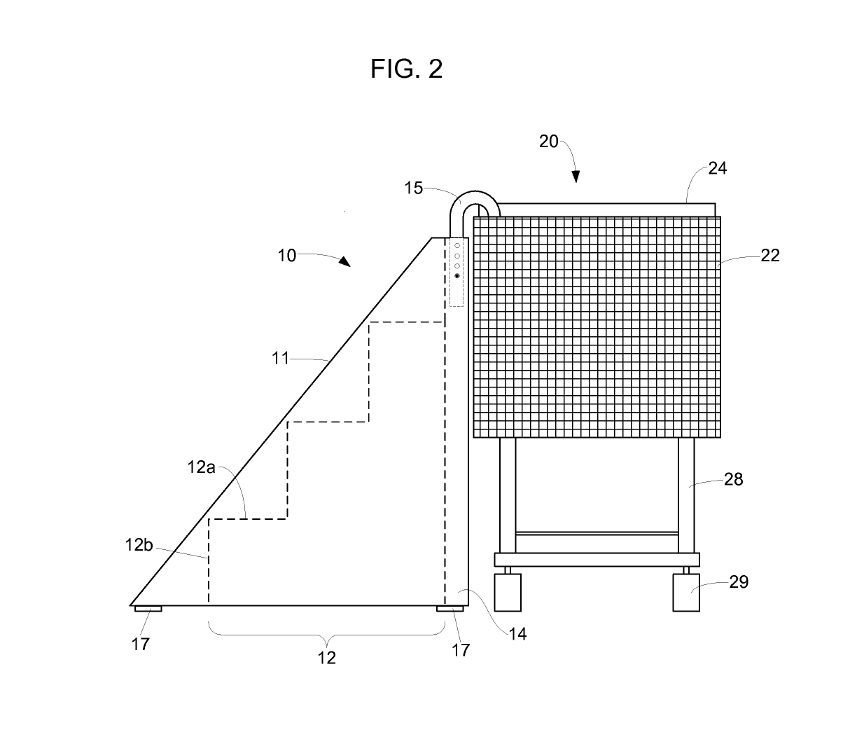

FIGS. 2-4 further illustrate climbing apparatus 10 and shopping cart 20. Shopping cart 20 is a traditional shopping cart comprising a basket 22, a support frame 28, a plurality of wheels 29, a cart handlebar 26, seat 25, seat back 24 and shopping cart sides 21. Shopping cart 20 can be formed of metal components, plastic components, or a combination thereof. The seat 25 and seat back 24 of shopping cart 20 are traditionally located near the handle end of shopping cart 20, as is shown in the illustrations. Seat 25 and seat back 24 are typically sized to accommodate toddlers and preschool-age children.

Climbing apparatus 10 of the present invention is configured to cooperate with shopping cart 20 such that a toddler or preschool-age child can climb climbing apparatus 10 with assistance from an adult and therefore gain access to the seat 25 while limiting the amount of lifting required by the adult.

As shown in the Figures, climbing apparatus 10 comprises two side walls 11, a plurality of steps 12, an end wall 13, two corner members 14, two adjustable handles 15, and optional feet 17. The plurality of steps 12 are positioned between substantially parallel side walls 11 and next to end wall 13. End wall 13 is substantially perpendicular to side walls 11 and positioned between corner members 14. Corner members 14 connect side walls 11 to end wall 13 and form a housing for receiving adjustable handles 15. Adjustable handles 15 reciprocate vertically in end wall 13 and preferably can be locked in one or more positions with a locking mechanism.

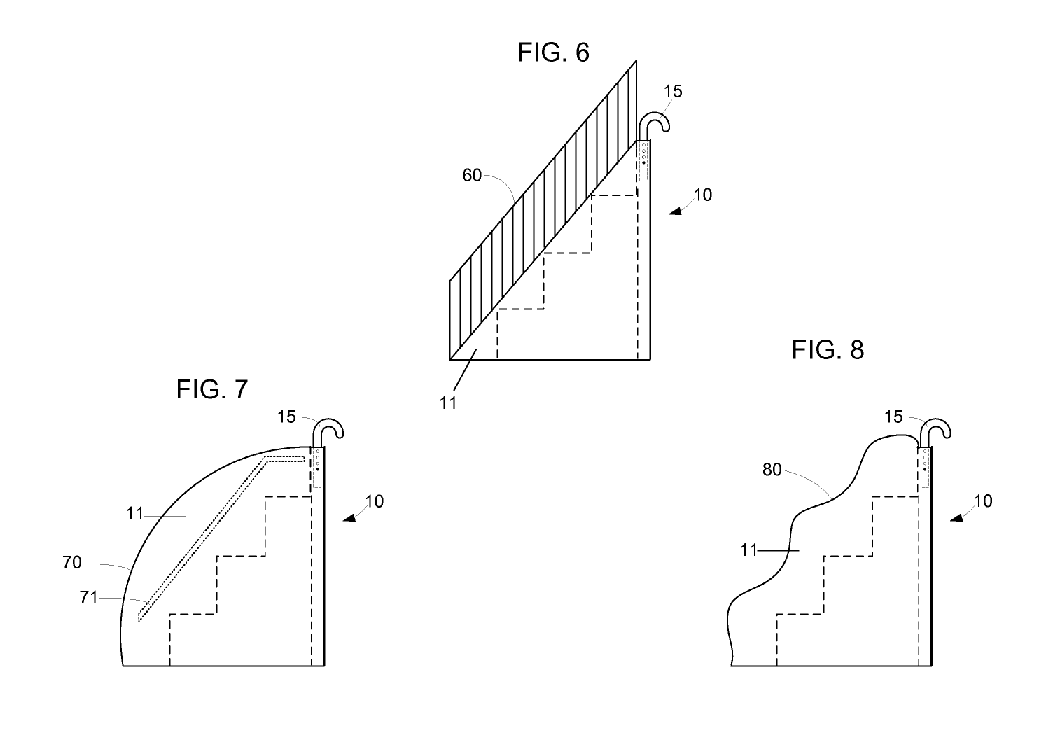

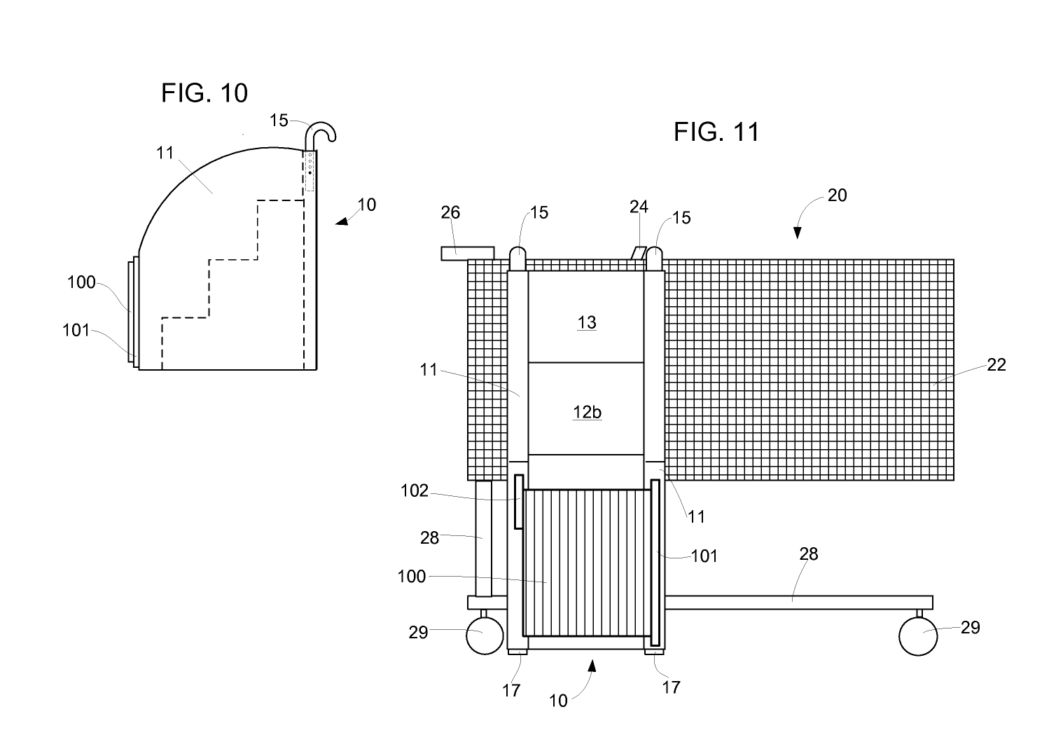

Side walls 11 are preferably substantially parallel as shown in the Figures. Alternatively, side walls 11 can be angled such that some steps are wider than other steps. Side walls 11 also are preferably substantially triangularly shaped to accommodate the plurality of steps 12 positioned between the walls 11. FIGS. 1-4 illustrate the preferred shape of side walls 11. Alternative side walls can include an extended edge 60 as shown in FIG. 6, a curved edge 70 as shown in FIG. 7, an irregular edge 80 as shown in FIG. 8, or a combination of these edges as shown in FIG. 10. Additionally and optionally, side walls can further include a railing 71. Railing 71 can be integral with side walls 11 or fixably attached to side walls 11. Side walls 11 are preferable comprised of non-toxic and eco-friendly injection molded plastic as is typically used for manufacturing children's climbing toys. Alternatively, side walls can be constructed with any metal, wood, or a wood-plastic composite. Side walls can be hollow, solid, or any combination thereof.

End wall 13 is preferably extends the height of climbing apparatus 10 at its higher end as is shown in the Figures. Like side walls 11, end wall 13 is preferably comprised of non-toxic and eco-friendly injection molded plastic as is typically used for manufacturing children's climbing toys. Alternatively, end wall 13 can be constructed with any metal, wood, or a wood-plastic composite. End wall 13 can be hollow, solid, or any combination thereof. End wall 13 can be an independent component or it can be integrated with another component such as corner members 14, side walls 11, or steps 12.

End wall 13 is perpendicular to side walls 11 and positioned between side walls 11 as is shown in the Figures. Each side wall 11 is joined to end wall 13 with a corner member 14. Corner members 14 are preferably partially or substantially hollow to accommodate vertically reciprocating adjustable handles 15. Corner members 14 can have a square cross-section, a circular cross-section, or any other shape cross-section as long as it accommodates adjustable handles 15. Corner member 14 can be an independent component that is fixable attached to end walls 13 and side walls 11 with an adhesive or with fasteners as is known in the art. Alternatively, corner member 14 can be integral with side walls 11 and end wall 13. Like side walls 11 and end wall 13, corner members 14 are preferably comprised of non-toxic and eco-friendly injection molded plastic as is typically used for manufacturing children's climbing toys. Alternatively, corner members 14 can be constructed with any metal, wood, or a wood-plastic composite.

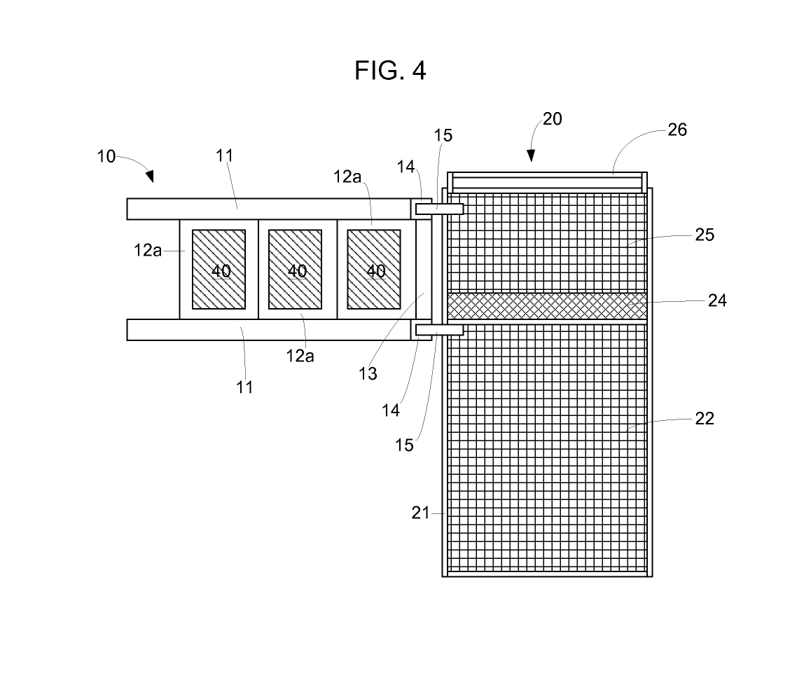

Plurality of steps 12 comprise two or more ascending steps comprising a vertical surface 12b and horizontal surface 12a as is shown in the Figures. Steps 12 ascend relative to the floor or ground upward from a lower location away from end wall 13 to a higher location adjacent end wall 13. Steps 12 are secured between the substantially parallel side walls 12 and fixedly or integrally connect with end wall 13. The number of steps can vary depending on the desired size and footprint of the overall climbing apparatus 10. Preferably, there are three steps 12 each comprising a vertical surface 12b and horizontal surface 12a. Like side walls 11, steps 12 are preferably comprised of non-toxic and eco-friendly injection molded plastic as is typically used for manufacturing children's climbing toys. Alternatively, steps 12 can be constructed with any metal, wood, or a wood-plastic composite. Steps 12 can be solid, hollow, or any combination thereof. Additionally, a slip-resistant coating or slip-resistant features 40 can be optionally included on each steps horizontal surface 12a, as is shown in FIG. 4. Slip resistant features include grooves, pebbling, grippers, and rough surfaces as is known in the art.

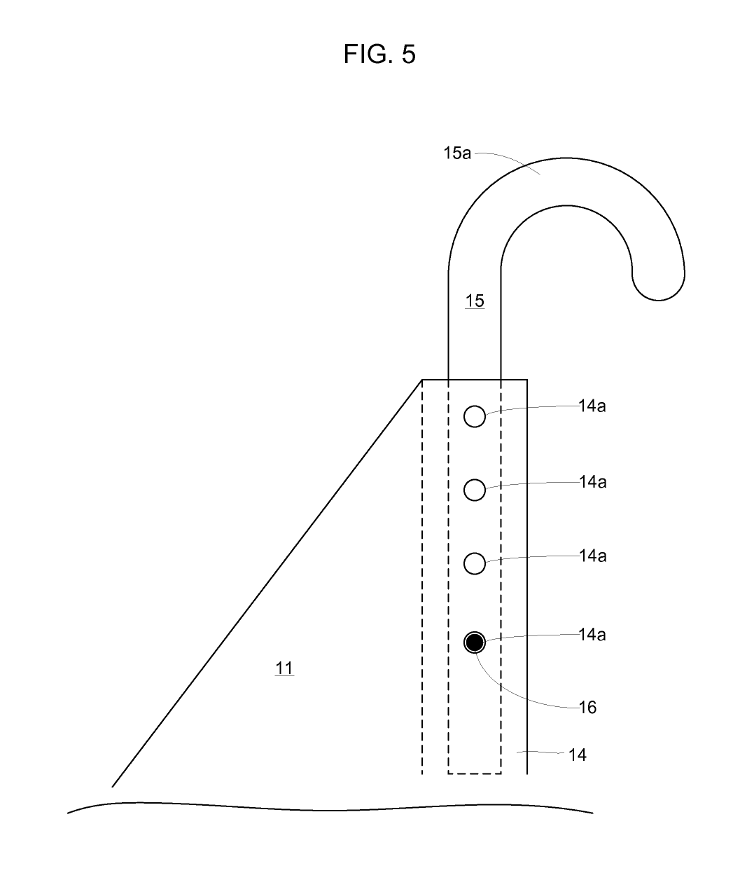

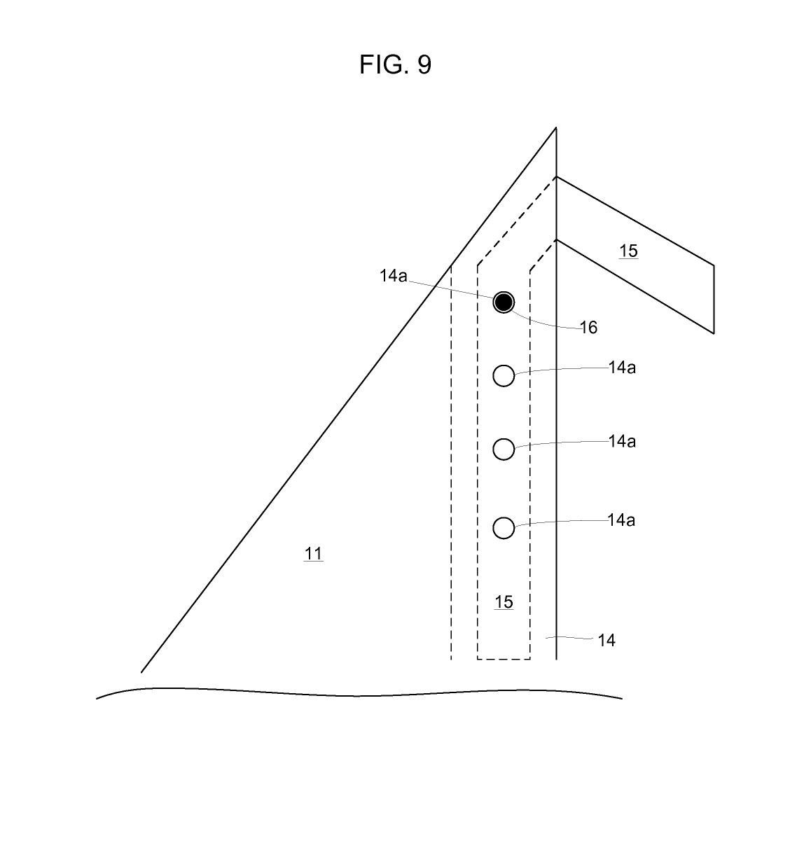

Adjustable handles 15 are shown in detail in FIG. 5. Adjustable handles 15 preferably comprise a curved end 15a that extends from corner members 14 and above end wall 13. Curved end 15a is shaped to accommodate a side 21 of a shopping cart basket. Curved end 15a is preferably shaped so that it is capable of extending up and over the side wall of shopping cart 20 to minimize shifting of cart 20 when climbing apparatus 10 is positioned next to shopping cart 20. Curved end 15a can be any curved or angular shape as long as it extends up and over the side 21 of the cart. Alternatively, for some applications, curved end 15a may only need to partially extend, in which case curved end 15a may be L-shaped. Also alternatively, adjustable handles 15 can extend from the upper surface of corner members 14 as shown in FIG. 5 or from a side surface of corner members 14 as shown in FIG. 9.

Handles 15 are slidably positioned within corner members 14 such that each handle 15 vertically reciprocates with respect to the ground or floor. Handles 15 can be made of non-toxic and eco-friendly molded plastic, wood, metals, wood-plastic composites, or rubber.

Handles 15 further each comprise a handle locking mechanism such that each handle can be locked at one or more vertical positions. Preferably, handles 15 reciprocate and can be locked independent of each other such that they can be adjusted to different heights to accommodate a sloped side 21 of a cart. Preferably, as shown in FIG. 5, the locking mechanism comprises a button 16 that cooperates with one or more notches 14a formed in corner member 14. Button 16 extends through notch 14a to hold adjustable handle 15 in a locked vertical position. Button 16 is biases radially outward from handle 15 by a spring mechanism as is known to someone skilled in the art. To adjust handle 15, button 16 is depressed by a caregiver to release handle 15. Handle 15 can they be slid vertically to a different position until the button 16 extends through a different notch. To prevent handles 15 from twisting as they are vertically displaced, handles 15 can be further aligned within corner member 14 with slots and grooves as is known to someone skilled in the art. While only one button 16 is shown in the Figures, multiple buttons 16 are acceptable as well. Alternative locking mechanisms known to someone skilled in the art can be substituted such as conventional button locks, pivot locks, or slide locks.

Additional optional components can further enhance the safety of climbing apparatus 10. For example, non-skid feet 17 can be secured to the underside of side walls 11 or end wall 13 to prevent climbing apparatus 10 from shifting when a child is climbing the steps. Also, a gate or barrier can be located at the lower end of steps 12 to prevent a child from ascending the steps without adult supervision. Further, a child safety lock can be include with the gate or barrier.

FIGS. 10 and 11 illustrate one embodiment of an optional safety gate 100. As shown, safety gate 100 pivotally secures to one of side walls 11 with a hinge 101. One or more hinges can be used to secure safety gate 100 to the climbing apparatus or any other fastener that allows the gate to swing open can be substituted. Additionally, while safety gate 100 is shown positioned at the end of side walls 11, safety gate 100 alternatively can be recessed and located between side walls 11. Safety gate 100 additionally includes a safety latch 102 for securing safety gate 100 in a closed position as shown in the Figures. Safety latch 102 can be any type of child safety lock or latch as is known to someone skilled in the art and typically includes a first set of components that attach to the gate 100 and second set of components that attach to the side wall 11. While safety gate 100 is shown as pivotally attached to side wall 11, safety gate alternatively can slide into place or otherwise placed into a position that creates a barrier. Safety gate 100 can be made of non-toxic and eco-friendly molded plastic, wood, metals, or wood-plastic composites.

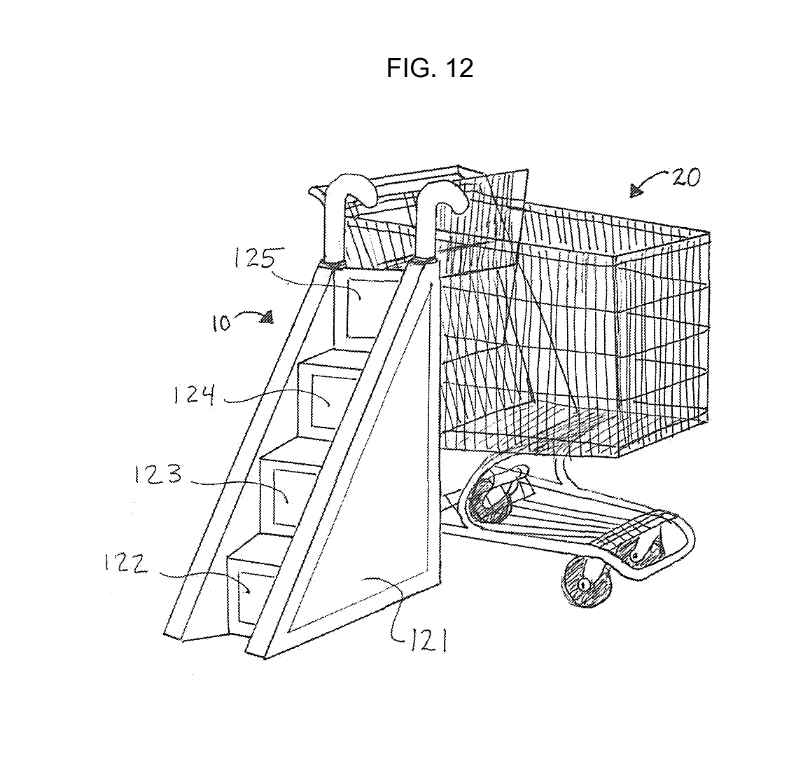

FIG. 12 illustrates further optional components of climbing apparatus 10. As shown, labels and instructions 120-125 can also be incorporated on side walls 11 or vertical surfaces 12b of steps 12. In one embodiment, recesses in side walls 11 and steps 12 can be formed to accommodate labels and instructions 120-125. Preferably, labels and instructions 120-125 include brand information, information about how to safely use the climbing apparatus, and warnings sufficient to discourage children from using the apparatus 10 without adult supervision.

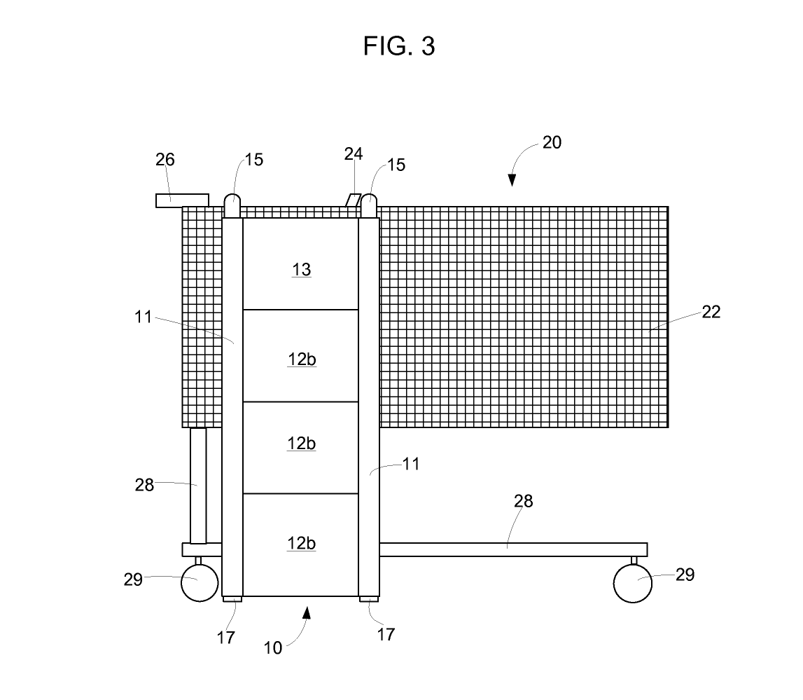

To use the climbing apparatus, an adult caregiver aligns shopping cart 20 with climbing apparatus 10 such that steps 12 of climbing apparatus 10 lead to the seat 24 of shopping cart 20. Alternatively, steps 12 can be aligned with the basket 22 if a child wants to ride in the basket. After aligning shopping cart 20 with climbing apparatus 10, the adult caregiver adjust handles 15 so that they extend up and over the side of shopping cart 20 to prevent the cart from shifting. Both handles 15 may be placed at the sides of the cart 20 between the cart handlebar 26 and the seat back 24. Alternatively, one of handles 15 may be placed behind seat back 24 as shown in FIG. 3.

Next, the adult caregiver assists the child as the child climbs steps 12. When the child reaches the highest step 12, the caregiver further assists the child as he steps over the side of cart 20 and into seat 25. After the child is properly seated in cart 20, the caregiver releases handles 15 so that they do not impede cart 20. The caregiver can then push cart 20 away from climbing apparatus 10 with the child safely in the cart. When the child is ready to leave the cart, the caregiver can again use climbing apparatus to assist the child as he climbs down from the cart.

While there has been illustrated and described what is at present considered to be the preferred embodiment of the present invention, it will be understood by those skilled in the art that various changes and modifications may be made and equivalents may be substituted for elements thereof without departing from the true scope of the invention disclosed, but that the invention will include all embodiments falling within the scope of the claims.

I claim:

1. A climbing apparatus comprising:
a. a first side wall;
b. a second side wall;
c. a plurality of steps fixably attached between the first side wall and second side wall;
d. a first corner member fixably attached to the first side wall; and
e. a first adjustable handle moveably secured to the first corner member.

2. The climbing apparatus of claim 1 further comprising a second corner member fixably attached to the second side wall and a second adjustable handle moveably secured to the second corner member.

3. The climbing apparatus of claim 2 further comprising an end wall fixedly attached to the first corner member and second corner member.

4. The climbing apparatus of claim 2 wherein the first corner member is integral with the first side wall and the second corner member is integral with the second side wall.

5. The climbing apparatus of claim 4 wherein the end wall is integral with the first and second corner members and first and second side walls and wherein the plurality of steps are integral with the end wall, first and second side walls, first and second corner members, and end wall.

6. The climbing apparatus of claim 5 wherein the first and second side walls, the first and second corner members, the end wall, and the plurality of steps comprise non-toxic molded plastic.

7. The climbing apparatus of claim 1 further comprising a first handle locking mechanism attached to the first adjustable handle.

8. The climbing apparatus of claim 7 wherein the first adjustable handle is disposed in the first corner member, wherein the first adjustable handle reciprocates vertically, and wherein the first handle locking mechanism comprises at least one first notch formed in the first corner member and a outwardly biased depressible button fixed to the first adjustable handle wherein the depressible button is configured to slide into the first notch when the adjustable handle is in a locked position.

9. The climbing apparatus of claim 3 wherein the first side wall comprises a substantially curved edge and wherein the second side wall comprises a substantially curved edge.

10. The climbing apparatus of claim 3 wherein the first side wall comprises an irregular edge and wherein the second side wall comprises an irregular edge.

11. The climbing apparatus of claim 3 further comprising a railing fixedly attached to the first side wall.

12. The climbing apparatus of claim 3 further comprising a safety gate assembly pivotally secured to the first side wall.

13. The climbing apparatus of claim 13 wherein the safety gate assembly comprises a gate having a first end and a second end, a hinge fixedly attached to the first end of the gate and fixedly attached to the first side wall, and first components of a safety latch fixedly attached to the second end of the gate and configured to cooperate with second components of the safety latch fixedly attached to the second side wall.

14. The climbing apparatus of claim 3 further comprising non-skid feet fixedly secured to the underside of the first and second side walls.

15. The climbing apparatus of claim 3 wherein the plurality of steps comprises two or more steps, wherein each step comprises a horizontal surface and a vertical surface, and wherein the horizontal surface of each step comprises a non-slip feature.

16. The climbing apparatus of claim 3 wherein the first adjustable handle reciprocates vertically within the first corner member and wherein the second adjustable handle reciprocates vertically within the second corner member.

17. The climbing apparatus of claim 16 wherein the first adjustable handle reciprocates independently of the second adjustable handle.

18. A climbing apparatus comprising:
a. a first side wall;
b. a second side wall;
c. a plurality of steps fixably attached between the first side wall and second side wall wherein each step comprises a horizontal surface and a vertical surface;
d. a first corner member fixably attached to the first side wall;
e. a first adjustable handle moveably secured to the first corner member;
f. a second corner member fixably attached to the second side wall;
g. a second adjustable handle moveably secured to the second corner member;
h. an end wall fixedly attached to the first corner member, the second corner member, and the plurality of steps;
i. a first handle locking mechanism attached to the first adjustable handle; and
j. a second handle locking mechanism attached to the second adjustable handle.

19. The climbing apparatus of claim 18 wherein the first and second side walls, the plurality of steps, the first and second corner members, and the end wall are integral and formed of molded plastic.

20. The climbing apparatus of claim 18 further comprising a safety gate assembly pivotally secured to the first side wall.
